(19) United States
(12) Patent Application Publication
(10) Pub. No.: US 2026/0250488 A1
(43) Pub. Date: Aug. 27, 2026

(54) METHOD OF MANAGEMENT OF FLY ASHES FROM THE COMBUSTION OF PETROLEUM PRODUCTS

(71) Applicant: RE-Solve Sp. z.o.o., Malbork (PL)

(72) Inventors: Mateusz CYMANSKI, Sztum (PL); Malgorzata OLEJARCZYK, Miastko (PL); Wlodzimierz URBANIAK, Poznan (PL); Joanna SZYMANSKA, Mosina (PL); Marek SZOSTAK, Swarzedz (PL); Dominik PAUKSZTA, Poznan (PL); Kamil ZIUZIAKOWSKI, Bydgoszcz (PL)

(73) Assignee: RE-Solve Sp. z.o.o., Malbork (PL)

(21) Appl. No.: 18/993,034

(22) PCT Filed: Jul. 15, 2023
(86) PCT No.: PCT/PL2023/050059

§ 371 Date: Jan. 10, 2025

(30) Foreign Application Priority Data
Jul. 18, 2022 (PL) P.441757
Jul. 18, 2022 (PL) P.441758
Jul. 18, 2022 (PL) P.441759
Jul. 18, 2022 (PL) P.441763

(51) Int. Cl. C08K 11/00; C01F 11/46; C01G 31/02; C01G 53/40; C09C 1/00; C09C 3/06; C22B 3/00; C22B 3/22; C22B 3/44; C22B 7/00; C22B 34/22

(52) U.S. Cl. CPC C08K 11/005; C01F 11/468; C01G 31/02; C01G 53/40; C09C 1/0081; C09C 3/06; C22B 3/22; C22B 3/44; C22B 7/007; C22B 23/043; C22B 23/0453; C22B 34/22; C01P 2002/60; C01P 2006/12; C01P 2006/40; C01P 2006/80; C08K 2201/006

(57) ABSTRACT

A method for utilization of fly ash derived from the combustion of petroleum-derived products includes a step of preparation of fillers, especially for thermoplastic polymers, or a step of recovery of metals, especially vanadium, from fly ash derived from the combustion of heavy fractions of petroleum-derived products. Also a filter is included in composites of thermoplastic polyolefin polymers, and the composites of thermoplastic polyolefin polymers include the filters.

The invention deals with a method for utilisation of fly ash derived from the combustion of petroleum-derived products which comprising a step of preparation of fillers, especially for thermoplastic polymers, or a step of recovery of metals, especially vanadium, from fly ash derived from the combustion of heavy fractions of petroleum-derived products. The invention provides also a filter and composites of thermoplastic polyolefin polymers comprising the filters according to the invention.

### TECHNICAL FIELD

The technical field of the invention is the management of fly ashes from the combustion of petroleum products.

### BACKGROUND ART

Fly ash is the solid residue from combustion captured in electrostatic precipitators. Fly ash from the combustion of solid fuels, particularly coal and lignite, is commonly known and used. Unlike coal ash, fly ash derived from the combustion of heavy oil fractions (HOFA-heavy oil fly ash), including heavy fuel oil (mazut), enjoys much less attention and interest. The quantities of ash produced are also much smaller compared to coal combustion. It is assumed that the combustion of 1 m³ of fuel oil generates approximately 2.5 kg of fly ash, in the form of very light dust with a density of approximately 0.4 kg/dm³, with unburned carbon being the main component, amounting from 30% to over 90% and inorganic components such as silicon, iron oxide, aluminosilicates and sulphur, as well as heavy metals, mainly vanadium and nickel [P. Kwolek, K. Czubajewski, M. Wojnicki, Separation and immobilization of vanadium from industrial fly ash as an insoluble inorganic pigment, Arch. Metall. Mater. 65 (2020), 2, 901-909, DOI: 10.24425/amm.2020.132837].

The vanadium content, depending on the origin of the oil and the combustion conditions, may range from 2.5% to 30% [Manaa E.S.A. Selective Leaching of Vanadium from Boiler Oiled Ash Residue Using Sodium Carbonate-Bicarbonate Binary Solution. Chem Technol Ind J. 2018; 13 (1): 124].

Due to the peculiar composition of fly ash under consideration, currently the main method for disposing of it is to store it in designated landfills. Only a relatively small proportion is used as a raw material for the extraction of valuable metals, mainly vanadium and nickel, or as an additive in the production of construction materials [Y.S. Al-Degs et al. Characterization and utilization of fly ash of heavy fuel oil generated in power stations, Fuel Processing Technology 123 (2014) 41-46, doi.org/10.1016/j.fuproc.2014.01.040].

Generally, vanadium compounds are leached from ash using acids or alkali. The precipitate that remains after the soluble components are leached in acids or alkalis, respectively, is usually considered to be waste. Following filtration, vanadium and other components are extracted from the resulting solutions by way of selective extraction or precipitation using properly selected precipitating agents.

Patent description U.S. Pat. No. 10,406,983 B2, (Vanadium recovery method) and publications [e.g. S. Vitolo et al. Recovery of vanadium from a previously burned heavy oil fly ash, Hydrometallurgy 62 (2001). 145-150], methods are known of using fly ash derived from the combustion of heavy fuel oils as a raw material for obtaining vanadium compounds after combustion of the carbon contained in the ash. This patent description discloses the methods with the proviso that in the first step the coal in the ash is burned, which results in a significant reduction, of up to 90%, in the weight of the ash from which vanadium is separated, and to a significant increase in its content in the carbon combustion residue.

Methods are also known that involve direct, i.e. without pre-burning the carbon contained in the ash, leaching of metallic components under acidic or alkaline conditions, followed by selective extraction of vanadium compounds from the resulting solutions using various solvents [A. Aburizaiza, Sequential Leaching of Vanadium from Heavy Fuel Oil Fly Ash Generated from Saudi Arabia Thermal Power Plants, Current Journal of Applied Science and Technology, 32 (4), 2019, pp. 1-17, doi: 10.9734/CJAST/2019/46032; R. Navarro et al., Vanadium recovery from oil fly ash by leaching, precipitation and solvent extraction processes, Waste Management 27 (2007) 425-438].

Methods involving direct leaching and extraction of vanadium compounds using various solvents are also known [A. Aburizaiza, Sequential Leaching of Vanadium from Heavy Fuel Oil Fly Ash Generated from Saudi Arabia Thermal Power Plants, Current Journal of Applied Science and Technology, 32 (4), 2019, pp. 1-17, doi: 10.9734/CJAST/2019/46032]. The main limitations of said methods involves problematic utilization of large volumes of effluent and sludge generated after the extraction/leaching processes, which are usually considered to be waste intended to be stored in a landfill.

Direct leaching of vanadium under alkaline conditions and its selective precipitation from the resulting solutions is known for example from patent descriptions U.S. Pat. No. 4,640,823 and WO 2019/193510 A1.

Methods involving leaching vanadium with acids are known for example from patent description U.S. Pat. No. 10,301,705 B2, where vanadium compounds are recovered in the form of an electrolyte solution used in redox flow batteries.

WO 2004/090179 description discloses a method for recovering vanadium from ash that involves dissolution of vanadium compounds in sulphuric acid at pH 1 to 1.5. Once the undissolved precipitate is filtered off, the resulting solution is treated with Na₂SO₃ to reduce the vanadium compounds to the tetravalent form. The solution is then brought to a pH of 5.2 to 5.5 with NaOH, and vanadium is precipitated as V₂O₄.

Due to its high carbon content, fly ash derived from the combustion of heavy fuel oil product fractions (HOFA) has been used as an additive in the production of Portland cement and geopolymers [M. Alshaaer et al., Production of Heavy Fuel Oil Fly Ash (HFO)-based Geopolymers for Passive Cooling Systems, International Journal of Applied Engineering Research, vol. 13 (1) 2018, pp. 137-143]. Said ashes has also been known to be used as a pigment for concrete. Here, metallic impurities in the HOFA are immobilised in the concrete matrix [Woo-Teck Kwon, Dong-Hyun Kim and Yung-Phil Kim Characterization of Heavy Oil Fly Ash Generated from a Power Plant “Advances in Technology of Materials and Materials Processing”, 6 [2] (2004) 260-263. DOI: 10.2240/azojomo0135].

HOFA is also known to be used as a raw material for the preparation of activated carbons [S. Salehin, et al. Activated carbon from residual oil fly ash for heavy metals removal from aqueous solution, Desalination and Water Treatment 57 (2016) 278-287, doi: 10.1080/19443994.2015.1006824; M. A. Rabah et al. Preparation of valuable products from cleaned carbon of fuel ash, AIMS Materials Science, 4 (5), 2017, 1186-1201. DOI: 10.3934/matersci.2017.5.1186].

The use of fly ash derived from the combustion of heavy fuel oils as asphalt additives is also known [patent application WO 2012/061371 A1, Utilization of heavy oil fly ash to improve asphalt binder and asphalt concrete performance], with the proviso that only ash containing more than 90% carbon, and, consequently, a small proportion of water- or acid-soluble components is used for this purpose.

WO 2017/182043 description also discloses composites based on a matrix of themoplastic polymers such as polyvinyl chloride, polyethylene or polypropylene, wherein the filler is ash derived from the combustion of oil shale. However, this type of ash, due to the high content of the mineral fraction derived from shale rock, is more similar in nature to ash derived from coal combustion.

The manufacture of thermoplastic polymer composites with mineral fillers in the form of powders, especially ash, is commonly known and currently used on a mass scale. Filling polymeric materials with mineral fillers improves the properties of the products, primarily by reducing the detrimental effect of thermal, post-reaction or post-crystallisation shrinkage of the products during their manufacture using various processing techniques as well as reducing the price of plastic products. The principles of a closed-loop economy, as well as economic considerations, make fly ash derived from the combustion of coal and lignite an interesting material. Such ash is characterised by a very high content of silicon, aluminium, as well as iron and calcium. Moreover, metals such as Cr, Co, Ni, Cu, Zn, Cd, Pb are also present in relatively small amounts [K. Galos, A. Uliasz-Bocheńczyk, “Źródła i użytkowanie popiołów lotnych ze spalania węgli w Polsce” Gospodarka Surowcami Mineralnymi, vol. 21 2005 no. 1, 23-42; T. Ratajczak et al. “Charakterystyka popiołów lotnych ze spalania niektórych węgli kamiennych i brunatnych”, Polskie Towarzystwo MineralogicznePrace Specjalne no. 13, 1999].

The use of this type of fly ash in composites is known [D. Czarnecka-Komorowska, M. Szostak, N. KujawaPopioły lotne są znane jako napełniacze tworzyw sztucznych Inż. Ap. Chem. 2010, 49, 5, 31-32; patent application WO2012083972A1 Composite of polymeric material with mineral fillers; Polish patent application P.398503, Sposób otrzymywania masy tworzywa kompozytowego z termoplastycznych tworzyw sztucznych i popiołów lotnych, powstałych w wyniku spalania węgli w jednostkach energetycznych].

### SUMMARY OF INVENTION

The essence of the invention is a method for utilisation of fly ash derived from the combustion of petroleum-derived products comprising extracting water- or acid-soluble components therefrom using water and/or acids, characterised in that water being added to the fly ash derived from the combustion of heavy fractions of petroleum at a ratio of 1:3 to 1:5 and at a temperature of 15° C. to 80° C., preferably 20° C. to 40° C.; this is mixed to produce a highly acidic solution with a pH below 2, preferably 0.5 to 1.5, possibly with the addition of a solution of sulphuric (VI) acid or sulphuric (IV) acid, followed by the resulting solution being separated from the undissolved precipitate using a known method, preferably by filtration or centrifugation, followed by the vanadium compounds being precipitated from the purified solution by adding an aqueous solution of a strong oxidant, preferably a 20 to 30% aqueous solution of hydrogen peroxide, maintaining the mixture at a temperature of 70° C. to 90° C., preferably 80° C. to 85° C. for 0.5 to 5 hours, preferably 1 to 2 hours. Now, other metals forming insoluble hydroxides, in particular nickel, iron and aluminium, are precipitated from the solution remaining after precipitation of vanadium, by increasing, using alkaline hydroxides, the reaction of the solution to 9.0 to 11.0, preferably 10.5, followed by, having filtered off the precipitate obtained under alkaline conditions, sulphates are precipitated from the resulting filtrate, using soluble calcium compounds, in the form of calcium sulphate. Now, the precipitate separated from the solution following the extraction of the combustion gas under consideration in the first step, is washed with water until the electrolytic conductivity of the filtrate is below 1 mS, followed by the precipitate being dried to a solid form.

In the first step of the inventive method, water-soluble and acid-soluble components are leached/extracted. Valuable components such as vanadium and nickel and sulphates in the form of gypsum are extracted in subsequent steps from the resulting solution, and the post leaching/extraction residue is used as a pigment and/or filler in composites with thermoplastic polymers such as polyethylene (PE) or polypropylene (PP). The use of fly ash in composites of this type is well known, but this concerns ash derived from the combustion of coal or lignite, which contains mainly mineral components [D. Czarnecka-Komorowska, M. Szostak, N. Kujawa “Kompozyty na bazie odpadów poliolefin napełnianych popiołami lotnymi” Inż. Ap. Chem. 2010, 49, 5, 31-32; patent application WO2012083972A1 Composite of polymeric material with mineral fillers; Polish patent application P.398503, Sposób otrzymywania masy tworzywa kompozytowego z termoplastycznych tworzyw sztucznych i popiołów lotnych, powstałych w wyniku spalania węgli w jednostkach energetycznych].

In the inventive method, the fly ash produced after the combustion of petroleum-derived products in the form of heavy crude oil fractions, especially heavy fuel oil, or oil distillation residues (HOFA), in which the carbon content (loss on ignition) ranges from approximately 40% to more than 90%, with the mineral components being mainly silicon compounds, iron, aluminium, sulphur and heavy metals: primarily vanadium, nickel or molybdenum, with water- and acid-soluble components accounting for 20 to 60%, separated by water leaching into a fraction insoluble in water and acids and a solution containing the dissolved compounds.

Heavy metals, mainly vanadium and nickel, as well as sulphates in the form of calcium sulphate, are selectively separated from the solution, and the solutions remaining after the separation of the precipitates are purified using membranes and nanofiltration. The purified water is returned to the process as the washing water, thus virtually eliminating the generation of effluent.

The essence of the invention is also a method for utilisation of fly ash derived from the combustion of petroleum-derived products comprising a step of preparing a filler, especially for thermoplastics, containing carbon, which comprises in adding water to fly ash derived from the combustion of heavy fractions of crude oil in a ratio of 1:3 to 1:5 and at a temperature of 15° C. to 80° C., preferably 20° C. to 40° C., mixing it until a highly acidic solution with a pH of less than 2, preferably 0.5 to 1.5, optionally adding a solution of sulphuric (VI) acid or sulphuric (IV) acid, followed by the resulting solution being separated from the undissolved precipitate using a known method, preferably by way of filtration or centrifugation. The resulting precipitate is washed with water until the electrolytic conductivity of the filtrate is below 1 mS, followed by the precipitate being dried to a solid form.

The essence of the invention is a filler, especially for thermoplastics, which contains carbon, in the form of a black powder comprises spherical porous particles with a grain size of 10 to 120 μm, mainly 30 to 80 μm, containing 50 to 80% carbon, mostly 70 to 75%, the other components being primarily compounds of silicon, iron, aluminium and sulphur, and with a specific surface area of more than 6 to 15 m²/g, derived from fly ash from the combustion of heavy oil fractions after separating acid-soluble metal and sulphur compounds therefrom.

The thermoplastic polyolefin polymer composite contains the filler used in an amount of 0.5 to 50% by weight based on the polymer matrix.

The method for utilisation of fly ash derived from the combustion of petroleum-derived products comprising a step of recovery of metals, especially vanadium, from fly ash derived from the combustion of heavy fractions of petroleum-derived products, comprising adding water to fly ash derived from the combustion of heavy fractions of crude oil in a ratio of 1:3 to 1:5 and at a temperature of 15° C. to 80° C., preferably 20° C. to 40° C., mixing it until a highly acidic solution with a pH of less than 2, preferably 0.5 to 1.5, optionally adding a solution of sulphuric (VI) acid or sulphuric (IV) acid, followed by the resulting solution being separated from the undissolved precipitate using a known method, preferably by way of filtration or centrifugation. Vanadium compounds are then precipitated from the purified solution by adding an aqueous solution of a strong oxidant, preferably a 20 to 30% aqueous solution of hydrogen peroxide, keeping the mixture at a temperature of 70° C. to 90° C., preferably 80° C. to 85° C. for 0.5 to 5 hours, preferably 1 to 2 hours.

Other metals that form insoluble hydroxides, in particular nickel, iron and aluminium, are precipitated from the solution remaining after removal of the vanadium compounds, to increase the pH of the solution to 9.0 to 11.0, preferably 10.5, using alkaline hydroxides. Once the precipitate obtained under alkaline conditions is filtered off, sulphates in the form of calcium sulphate are precipitated from the resulting filtrate using soluble calcium compounds.

Preferably, once the calcium sulphate precipitate is removed, the filtrate is purified using membrane and nanofiltration methods, to yield pure water returned to the process and a concentrate in the form of brine.

### Technical Problem

The main limitations of said methods involves problematic utilization of large volumes of effluent and sludge generated after the extraction/leaching processes, and the necessity to use large quantities of chemicals to selectively precipitate solution components.

### Solution to Problem

Surprisingly, it was found that fly ash derived from the combustion of heavy crude oil fractions, in particular heavy fuel oil and oil distillation residues, can be virtually completely recycled in several processing steps. Moreover, it was found that, under suitable conditions, it was possible to recover virtually all of the vanadium and selectively the other ash components dissolved in water, with little use of additional chemicals and reduced effluent generation.

Surprisingly, it was found that the fly ash produced after the combustion of petroleum-derived products in the form of heavy crude oil fractions, especially heavy fuel oil, or oil distillation residues, in which the loss on ignition ranges from approximately 40% to more than 90%, with the mineral components being mainly silicon compounds, iron, aluminium, sulphur and heavy metals: primarily vanadium, nickel, molybdenum or zinc, after leaching acid-soluble heavy metal compounds, may be used as fillers and pigments for composites based on thermoplastic polyolefins, such as polyethylene, polypropylene and recyclates thereof.

The residue remaining after leaching water- and acid-soluble compounds, in the form of a free-flowing black powder, comprises spherical, porous particles with a grain size of approximately 10 to 120 μm, mainly 30 to 80 μm, and a specific surface area of at least 6 to 15 m²/g, comprising mainly of carbon, more than 70 to 75%, and such components as silicon, iron and aluminium, for which the electrolytic conductivity of a standard water extract (S: L ratio=1:10) is below 1.0 mS, may be used as a filler for composites based on thermoplastic polyolefins, such as polyethylene, polypropylene or recyclates thereof.

According to the invention, it was found that composites with very good mechanical and processing properties may be obtained using a filler derived from fly ash generated by the combustion of petroleum-derived products in the form of heavy petroleum-derived fractions, especially heavy fuel oil, or crude oil distillation residues (HOFA), in which the loss on ignition ranges from approximately 40% to more than 90%, containing from 50 to 80% carbon, with the mineral components being mainly compounds of silicon, iron, aluminium, sulphur and heavy metals; primarily vanadium, nickel, molybdenum or zinc, after leaching the soluble compounds in a highly acidic environment.

### Advantageous Effects of Invention

The present invention allows for the recovery and further use of all fly ash components generated in power plants during the combustion of heavy fractions of petroleum-derived products, especially heavy fuel oil or oil distillation residues.

Heavy metals from the HOFA are leached primarily using water, which forms a highly acidic solution (with a pH less than 1) with sulphur compounds, in particular SO₂. Under these conditions, through repeated leaching, all acid-soluble components are removed. Elemental analysis showed that the post-leaching residue, which is the inventive filler, comprising mainly of carbon: more than 70 to 75%, while XRF analysis also revealed the presence of silicon, iron and aluminium. The resulting precipitate, unlike carbon black-type fillers, has hydrophilic properties.

Studies have shown that the resulting material has very good properties as an active enhancing filler in polyolefin composites. It also has very good colouring properties as a black pigment. Even at a content of 1% in the composite, the intensity of the black colour is comparable to that of the composite containing 30% filler, regardless of whether pure polymer or coloured recyclate was used.

The manufacture of a composite of polyolefins and filler according to the invention involves mixing a filler in an amount of 0.5 to 50 wt. % relative to the polymer matrix in a suitable proportion with the polyolefins and processed into a finished product using known methods.

The resulting composites, regardless of the matrix type, showed an increase in Young's modulus values with increasing filler amount, and for polyethylene matrix and PE recyclates, an increase in tensile strength was also found. The inventive composites, even those having a considerable proportion, up to 50%, of filler, are characterised by parameters at least similar to the polymer matrix, while the Young's modulus and tensile strength increase, even by more than 50%, compared to the unfilled polymer, regardless of the polyolefin matrix used. For all composites tested, a reduction in elongation at break was found, while for the isotactic polypropylene with the addition of 20% filler, an increase in impact strength for notched specimens of almost 30% was found.

### EXAMPLES

The invention is illustrated by the following examples.

### Example I

To 100 g of fresh fly ash derived from the combustion of heavy crude oil fractions, with a bulk density of approximately 0.36 kg/dcm3, which shows a loss on ignition of more than 60% and a content of 5% vanadium, 4% nickel and 12% iron, 350 ml of demineralised water was added and stirred vigorously for 3 hours at room temperature. A significant proportion of the ash (more than 40%) dissolved, and the pH of the resulting mixture stabilised at 0.8 pH. The mixture was then filtered, and the remaining precipitate was washed, with the solution from the first filtration and the solutions from washing the precipitate being collected separately. After washing, the precipitate may be used as a filler in composites with thermoplastic polyolefin materials. Using the solution from the first filtration (without washing the precipitate with water), acid-soluble compounds were separated in subsequent steps, while the filtrate from the precipitate wash was used to process the next batch of raw ash instead of demineralised water.

### Example II

To 100 g of fly ash derived from the combustion of heavy crude oil fractions, with a bulk density of approx. 0.45 kg/dcm³, containing approx. 10% vanadium, 4% nickel, 6% iron, 13% sulphur and small amounts of aluminium, magnesium and zinc, 350 ml of demineralised water was added and stirred vigorously for 1 hour at the temperature of approx. 60° C. A significant proportion of the ash (approx. 60%) dissolved, and the pH of the resulting mixture stabilised at a pH of approx. 3.5, which was lowered to pH 1.5 by adding a solution of sulphuric (VI) acid or sulphuric (IV) acid. The further procedure was as in Example I.

### Example III

To the solution from the first filtration of the mixture of Example I, containing approximately 44 g/L of dissolved vanadium, 60 ml of a 20% aqueous solution of hydrogen peroxide was added and then heated to a temperature of approximately 70° C. and kept at this temperature for 2 hours. A brownish-black precipitate containing vanadium in the form of oxides with a small, less than 2%, impurity content, mainly iron compounds, precipitated. The precipitate, which is the raw material used for obtaining pure vanadium compounds, was separated from the solution by way of filtration.

### Example IV

The procedure for the solution from Example II was as in Example III: 35 ml of a 30% hydrogen peroxide solution was added and heated at a temperature of approximately 85° C. for 1 hour. As in Example III, a brownish-black precipitate containing vanadium in the form of oxides with minor impurities precipitated.

### Example V

To the filtrate of Example III, following separation of the vanadium compounds, a soda lye solution was added to obtain a pH of approximately 10.5, precipitating the remaining alkali-insoluble metals, mainly nickel, iron and aluminium, and the resulting mixture was filtered. The post-filtration precipitate, containing significant amounts of nickel, is the raw material used for obtaining nickel compounds, while the post-filtration solution, containing large amounts of sulphate, is the raw material used for obtaining calcium sulphate (gypsum plaster).

### Example VI

A solution of calcium chloride was added to the post-filtration solution of Example IV in an amount sufficient to allow complete precipitation of sulphates in the form of calcium sulphate. Following filtration, the resulting precipitate is the raw material used for obtaining gypsum plaster. The resulting filtrate was purified using membrane and nanofiltration methods, to yield clean water returned to the process, and a brine concentrate, thus practically eliminating the production of effluent.

### Example VII

The washed precipitate from Example 1 was dried to a solid mass. The resulting free-flowing black powder, comprises spherical, porous particles with a grain size of approximately 10 to 120 μm, mainly 30-80 μm and a specific surface area of 6 to 15 m²/g, was subjected to a physicochemical analysis. The electrolytic conductivity of the standard water extract (S: L ratio=1:10) was below 1.0 mS. Elemental analysis showed that the powder mainly comprised carbon with more than 70 to 75%, while XRF analysis also revealed the presence of silicon, iron and aluminium. The resulting precipitate showed hydrophilic properties.

### Example VIII

For the precipitate in Example II, the procedure was as in Example VII. The resulting product had properties like the product in Example VII.

### Example IX

The precipitate from Example 1 was dried for 12 hours at the temperature of 80° C., followed by mixing in various proportions with pellets of polyolefin thermoplastic polymers: Tatren HT3 06 polypropylene from Slovnaft, Malen E FABS 23-D022 polyethylene from Basell Orlen Polyolefins and recycled polyethylene. The designations and characteristics of the composites obtained are summarised in Table 1.

TABLE 1
Characteristics of the systems analysed

| | |
|---|---|
| Designation | Description - filler content |

Tatren HT 3 06 polypropylene composites

| | |
|---|---|
| PP_1C | 1% carbon filler |
| PP_20C | 20% carbon filler |
| PP_30C | 30% carbon filler |

Malen polyethylene composites

| | |
|---|---|
| PE | Control test |
| PE_30C | 30% carbon filler |

Recycled polyethylene composites

| | |
|---|---|
| R | Control test |
| R_30C | 30% carbon filler |

### Example X

The mixtures obtained in Example IX were placed in the hopper of an ENGELES 80/20 HLS injection moulding machine and subjected to injection process in the conditions as follows: injection speed: 30 mm/s, cooling time: 35s, packing pressure: 30 MPa, packing time: 7s, nozzle temperature: 220° C., mould temperature: 35° C. The pellets were used to form dumbbell-shaped mouldings in accordance with PN68/C-89034 standard, which were subjected to mechanical tests: static tensile test (in accordance with PN-EN ISO 527:2012 standard) and Charpy impact test for notched specimens (in accordance with PN-EN ISO 179-1:2010 standard). The results obtained are summarised in Table 2.

TABLE 2
Strength test results.

| | Young's | Tensile | Elongation | Tensile |
|---|---|---|---|---|
| | modulus | breaking | at break | breaking |
| Specimen | [MPa] | strength [MPa] | [%] | strength [KJ/m2] |
| PP | 1640 | 35.6 | 7.38 | 4.1 |
| PP_1C | 1680 | 35.5 | 7.0 | 3.9 |
| PP_20C | 2230 | 35.5 | 4.6 | 5.3 |
| PP_30C | 2450 | 36.1 | 4.1 | 3.9 |
| PE | 233 | 8.75 | 46.7 | 11.6 |
| PE_30C | 499 | 13.8 | 18.42 | 14.1 |
| R | 334 | 10.6 | 81.8 | 93.5 |
| R_30C | 697 | 16.3 | 16.9 | 63.5 |

Also, water absorption of the resulting composites was tested. In spite of the hydrophilic properties of the filler, the increase in water absorption of the resulting composites was small: less than 0.5% after 90 days, thus practically not much more than that of the pure polymers.

The black colour intensity of the resulting composites was compared. Even with the 1% filler content of Example III in the composite, the intensity of the black colour is comparable to that of the composite containing 30% filler, regardless of whether pure polymer or coloured recyclate was used.

In spite of the hydrophilic properties of the filler, the increase in water absorption of the resulting composites was small: less than 0.5% after 90 days.

### INDUSTRIAL APPLICABILITY

The precipitated vanadium oxides are the finished product or may be used as the raw material for obtaining pure vanadium compounds, for example in the form of ammonium salts.

The undissolved precipitate, obtained after the first filtration, may be used as a filler or pigment in composites with polyolefin thermoplastic polymers (PE, PP).

The resulting composites are characterised by an intense black colour already at a filler content of 1% in the composite, regardless of whether pure polymer or coloured recyclate was used.

Moreover, DSC studies have shown that composites in which fillers were used obtained from fly ash derived from the combustion of petroleum-derived products increase the crystallisation temperature of the composite by several degrees, which increases the range of processing parameters.

1. A method for utilization of fly ash derived from the combustion of petroleum-derived products comprising a step of preparing a filler, especially for thermoplastics, containing carbon, comprising adding water to fly ash derived from the combustion of heavy fractions of crude oil in a ratio of 1:3 to 1:5 and at a temperature of 15° C. to 80° C., preferably 20° C. to 40° C., mixing it until a highly acidic solution with a pH of less than 2, preferably 0.5 to 1.5, optionally adding a solution of sulfuric (VI) acid or sulfuric (IV) acid, followed by the resulting solution being separated from the undissolved precipitate using a known method, preferably by way of filtration or centrifugation, followed by washing the resulting precipitate with water until the electrolytic conductivity of the filtrate is below 1 mS, followed by the precipitate being dried to a solid form.

2. A filler, especially for thermoplastics, containing carbon, wherein the filler is a black powder comprising spherical porous particles with a grain size of 10 to 120 μm, mainly 30 to 80 μm, containing 50 to 80% carbon, mostly 70 to 75%, with the other components being primarily compounds of silicon, iron, aluminum and sulfur, and with a specific surface area of more than 6 to 15 m²/g, derived from fly ash from the combustion of heavy oil fractions after separating acid-soluble metal and sulfur compounds therefrom.

3. A thermoplastic polyolefin polymer composite with a filler derived from fly ash, wherein the filler according to claim 2 is used in an amount of 0.5 to 50% by weight based on the polymer matrix.

4. A method for utilization of fly ash derived from the combustion of petroleum-derived products comprising a step of recovery of metals, especially vanadium, from fly ash derived from the combustion of heavy fractions of petroleum-derived products, comprising in leaching metals in an acidic environment and selective precipitation of metals from the solution obtained, wherein water is added to the fly ash derived from the combustion of heavy fractions of petroleum at a ratio of 1:3 to 1:5 and at a temperature of 15° C. to 80° C., preferably 20° C. to 40° C.; this is mixed to produce a highly acidic solution with a pH below 2, preferably 0.5 to 1.5, possibly with the addition of a solution of sulfuric (VI) acid or sulfuric (IV) acid, followed by the resulting solution being separated from the undissolved precipitate using a known method, preferably by filtration or centrifugation, followed by the vanadium compounds being precipitated from the purified solution by adding an aqueous solution of a strong oxidant, preferably a 20 to 30% aqueous solution of hydrogen peroxide, maintaining the mixture at a temperature of 70° C. to 90° C., preferably 80° C. to 85° C. for 0.5 to 5 hours, preferably 1 to 2 hours, while as an option, other metals forming insoluble hydroxides, in particular nickel, iron and aluminum, are precipitated from the solution remaining after precipitation of vanadium, by increasing, using alkaline hydroxides, the reaction of the solution to 9.0 to 11.0, preferably 10.5, followed by, having filtered off the precipitate obtained under alkaline conditions, sulfates are precipitated from the resulting filtrate, using soluble calcium compounds, in the form of calcium sulfate.

5. The method according to claim 4, wherein the filtrate, once the calcium sulphate precipitate is removed, is purified using membrane and nanofiltration methods, to yield pure water returned to the process and a concentrate in the form of brine.
